(19) United States
(12) Patent Application Publication
(10) Pub. No.: US 2012/0079925 A1
(43) Pub. Date: Apr. 5, 2012

(54) KNIFE HOLDER OF A TUBE CUTTING UNIT FOR TUBE MANUFACTURING AND A SYSTEM AND USE OF THE SYSTEM FOR TUBE MANUFACTURING

(76) Inventors: Carina Petersson, Forslov (SE); Sandra Philipsson, Bastad (SE); Niklas Svensson, Bastad (SE); Lars Karlsson, Vejbystrand (SE)

(21) Appl. No.: 13/145,170

(22) PCT Filed: Feb. 25, 2010
(86) PCT No.: PCT/SE2010/050220

§ 371 Date: Sep. 12, 2011

(30) Foreign Application Priority Data
Feb. 27, 2009 (SE) 0900262-7

(51) Int. Cl. B23D 21/04

(52) U.S. Cl. 82/54

(57) ABSTRACT

The invention relates to a knife holder (402) for a tube cutting unit (400), which tube cutting unit (400) is adapted to receiving a rotating tube (2) fed out from a tube manufacturing device (1) in a feed direction (316). The feed direction (316) for one length unit is parallel with the longitudinal direction of the tube (2). The rotation of the tube (2) takes place about an axis (310) in the longitudinal direction of the tube (2). The knife holder (402) is configured to be adapted to being movable via bearing elements (414) on the knife holder (402) which communicates with fastening elements (416) disposed on the tube cutting unit (400). The knife holder (402) comprises first and second shaft-bearing parts (410, 412) between which a shaft (408) supporting a knife element (404) with cutting edge (406) is fitted.

### FIELD OF THE INVENTION

The present invention relates to a knife holder, a tube cutting unit with the knife holder, a system for tube manufacture with the tube cutting unit, and use of such a system for manufacture of tubes.

### BACKGROUND TO THE INVENTION

American specification U.S. Pat. No. 5,992,275 refers to a tube manufacturing device for manufacture of tubes. The tube manufacturing device is fed with a continuous metal strip which is shaped before it enters the device. The tube manufacturing device is provided with a forming head which imparts a spiral shape to the metal strip. Together with the forming head, the tube manufacturing device comprises an element adapted to putting the edge portions of the strip together by seaming to constitute the spirally formed tube. This process and feeding of metal strip to the forming head take place continuously and the feed direction of the tube is parallel with its longitudinal direction.

When the tube has been made to a desired length in the feed direction, it has to be cut. Cutting is effected by a knife element fitted in a knife holder which is part of a cutting unit in the tube manufacturing device. Cutting involves the knife element being placed against the rotating tube and travelling during the cutting process at the feed rate of the tube and parallel with a centreline of the tube during continuous rotation of the tube. After one revolution of the tube, the knife element will have cut a full turn in the surface of the tube, thereby dividing the tube into two parts. The fact that the tube rotates against the knife element in a direction and is at the same time pressed against the knife element to cause the knife element to cut through the surface of the tube results in a force against the knife element. This force is transmitted to a shaft which supports the knife element and thence to the actual knife holder of the knife element. The rotation from the tube and the pressing force from the tube against the knife element result in a force component in the knife holder. This force component in the knife holder is angled relative to the feed direction of the tube. The force component therefore acts upon the knife holder asymmetrically, so the shaft and the knife holder will endeavour to pivot in the tube manufacturing device. This results in knife holders according to U.S. Pat. No. 5,992,275 being subject to wear, inter alia because the fastenings between knife holder and tube cutting unit are disposed symmetrically and not adapted to absorbing a force component which is angled. As they are disposed symmetrically but subject to the action of various forces due to said force component, various parts of the knife holder will be subject to various kinds of wear.

In the state of the art, it is usual practice that the knife element for the knife holder is fitted on one end of a shaft and the other end of the shaft is fitted in the knife holder. This results in a force from the knife element against the shaft acting like a lever arm against the shaft. The shaft and also its fastenings are thus subject to wear, making it necessary to replace the shaft after a period of use. Recesses or fastenings for the shaft in the knife holder are also subject to wear due to the shaft being subject to lever bar effects in said recesses and/or fastenings.

### SUMMARY OF THE INVENTION

An object of the present invention is to achieve a knife holder which distributes the forces from the cutting operation evenly, thereby reducing wear.

Another object of the invention is to overcome the aforesaid problems of the state of the art.

A further object of the invention is to achieve a device and a method which are cost-effective as compared with traditional technology, which device is easy to construct, making it possible to optimise cost and time.

The aforesaid and other objects are achieved according to the invention by the knife holder described in the introduction being provided with the features arising from claim 1.

An advantage afforded by a knife holder according to claim 1 is that a force against the knife element can be distributed evenly to the knife holder.

Preferred embodiments of the device according to the invention are further provided with the features indicated by dependent claims 2-12.

According to an embodiment of the invention, the knife element is disposed centred between the shaft-bearing parts. An effect of this is that a force against the knife element during the cutting operation can thus be evenly distributed to the respective shaft-bearing parts.

According to a further embodiment of the invention, the position of the knife element along the shaft between the shaft-bearing parts can be varied. During use, the cutting edge of the knife element becomes worn, making it necessary to grind the knife element. The knife element has a thickness in the direction of the supporting shaft. During the grinding of the knife element, one side of it is ground, reducing the thickness of the knife element. This means that, after grinding, the cutting edge of the knife element is moved to the other side of the knife element. To compensate for the knife element between the sides having become thinner due to grinding and the cutting edge having thus been moved in an axial direction relative to the supporting shaft, the knife element is therefore so fitted that its position along the shaft can be varied. This makes it possible for the position of the cutting edge to be adjusted to the same position relative to the shaft as it had before the knife element was ground.

According to a further embodiment of the invention, the knife element is adapted to being rotatable. An effect of this is that the friction between the tube being cut and the cutting edge of the knife element will be less when the knife element can rotate as compared with if it cannot rotate.

According to a further embodiment of the invention, the knife element is adapted to cutting the tube in a direction transverse to the longitudinal direction of the tube. During the manufacturing process the tube's longitudinal direction is substantially parallel to the feed direction. During cutting of the tube, the knife holder travels with the knife element in the feed direction at a similar velocity to the tube's travel in that direction. At the same time, during that movement the tube rotates against the cutting edge of the knife element and is cut transversely to its longitudinal direction.

According to a further embodiment of the invention, a back-up is disposed opposite to the knife element in such a way that the back-up is within the periphery of the tube being made and cooperates with the knife element during the cutting operation. An effect of this is that the tube to be cut is thereby prevented from having its cutting region bent inwards towards its centreline. The reason for this is that in the cutting region the back-up abuts at least partly against the inside of the tube.

According to a further embodiment of the invention, each shaft-supporting part has a recess in which the shaft is fitted. This recess may for example be a U-shaped concavity in an upper portion of the respective shaft-bearing part, which upper portion faces towards the tube which is being cut. In another example, the recess may take the form of a hole not wholly running through the respective shaft-supporting part. In a further example, the recess may take the form of a hole running through the respective shaft-supporting part. Further variants comprise the possibility of said examples of various recesses being varied between two shaft-supporting parts. An example may be one shaft-supporting part being provided with a U-shaped milled-out recess in its upper portion, and the other shaft-supporting part being provided with the second recess in the form of, for example, a hole running through it. An effect of a recess is that it is adapted to supporting a shaft.

According to a further embodiment of the invention, the shaft is journalled in at least one shaft-supporting part. An effect of using a bearing is that the friction during rotation between the shaft and the shaft-supporting part can be reduced. A further effect is that a force which is to be distributed from the shaft to the shaft-supporting part by the use of a bearing in the recess will be evenly distributed. The reason is that a bearing can distribute a force to a plurality of contact points.

According to a further embodiment of the invention, the knife holder comprises a wall element disposed between the shaft-bearing parts. An effect of this is that the shaft-bearing parts thereby become rotationally and flexurally rigid. A further effect is that owing to the supporting wall element the shaft-bearing parts can be made thinner, making it possible to optimise the amount of material used.

According to a further embodiment of the invention, the knife holder comprises a bottom element from which the shaft-bearing parts protrude. An effect of the bottom element is to provide a solid unit with which and against which the respective shaft-bearing parts are disposed. A further effect of the bottom element is that a force exerted by a controlled unit against the bottom element can be distributed evenly across the bottom element. A counterforce from the respective shaft-bearing parts against the shaft between them can thus be evenly distributed.

According to a further embodiment of the invention, the knife holder takes the form of a unit in which the bottom element, the shaft-bearing parts and/or wall elements are created by machining of the knife holder. An effect of this is that the knife holder thus comprises no fastening elements adapted for holding the various parts together.

According to a further embodiment of the invention, the bearing elements on the knife holder are disposed in a plane which has a perpendicular direction which deviates from being parallel with the tube's longitudinal direction. This plane is disposed parallel with the movement direction in which the knife holder travels relative to the cutting unit when moving towards or away from a tube which is being cut. An effect of this is that the bearing elements are thus not disposed opposite one another on the knife holder.

According to a further embodiment of the invention, the bearing elements on the knife holder are disposed in a plane which has a perpendicular direction to the plane which is parallel with the tube's longitudinal direction. According to this embodiment, the plane is disposed parallel with the movement direction in which the knife holder travels relative to the cutting unit when moving towards or away from a tube which is being cut. An effect of this is that the bearing elements are therefore disposed opposite one another on the knife holder.

According to a further embodiment, the invention relates to a tube cutting unit for a tube manufacturing device which comprises a knife holder as above.

According to a further embodiment, the invention relates to a system which comprises a tube manufacturing device and a tube cutting unit as above.

According to a further embodiment, the invention relates to use of a system for manufacture of tubes which comprises a tube manufacturing device and a tube cutting unit as above.

### BRIEF DESCRIPTION OF THE DRAWINGS

A preferred embodiment of the device according to the invention is described below in more detail with reference to the attached schematic drawings, which only depict the parts which are necessary for understanding the invention.

FIG. 1 depicts a tube manufacturing device with forming head, cutting unit and a continuous metal strip which is fed from a feed device.

FIG. 2 depicts a tube manufacturing device with forming head, cutting unit and tube being made.

FIG. 3 depicts a knife holder for a cutting unit.

FIG. 4 depicts a knife holder with an imaginary plane.

### DETAILED DESCRIPTION OF VARIOUS EMBODIMENTS OF THE INVENTION

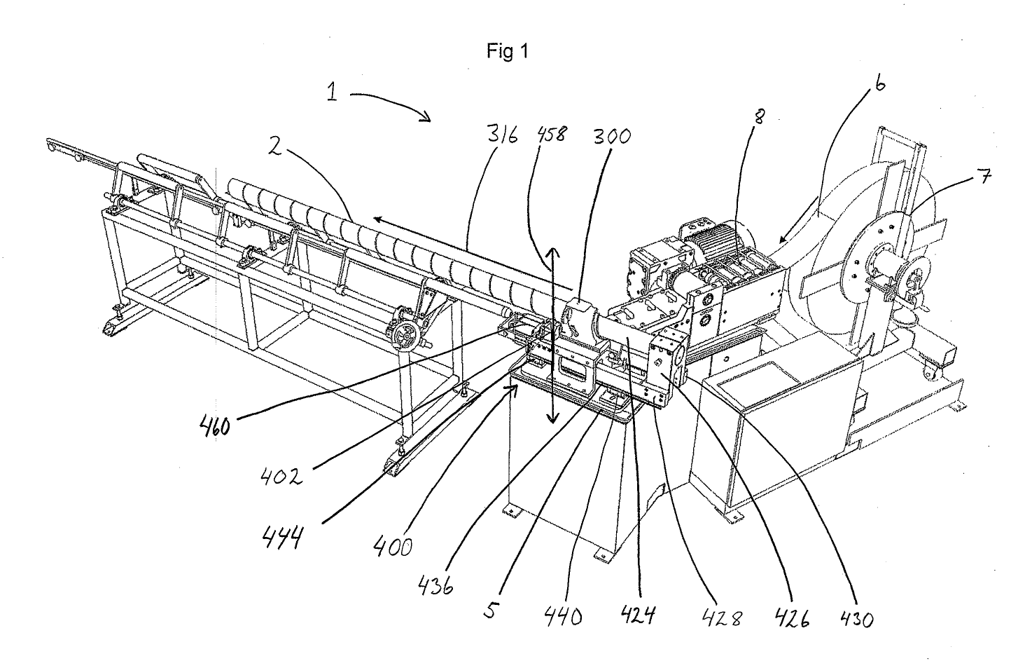

FIG. 1 depicts a tube manufacturing device 1 for manufacture of spirally formed tubes 2. The tube manufacturing device 1 comprises a forming head 300 and a cutting unit 400. A continuous metal strip 6 is fed, from a feed device 7 comprising the strip 6, to the tube manufacturing device 1 via a shaping mill 8 provided with powered rollers. When the strip 6 passes through the shaping mill 8, the powered rollers provide the strip 6 with desired correction and/or curvature. From the shaping mill 8, the processed strip 6 is led towards the forming head 300 disposed on the tube manufacturing device 1. The shaping mill 8 is preferably situated in the immediate vicinity of the tube manufacturing device 1 in such a way that they are connected to one another. The strip 6 is shaped by the forming head 300 to constitute a tube 2 which leaves the forming head 300 in a feed direction 316.

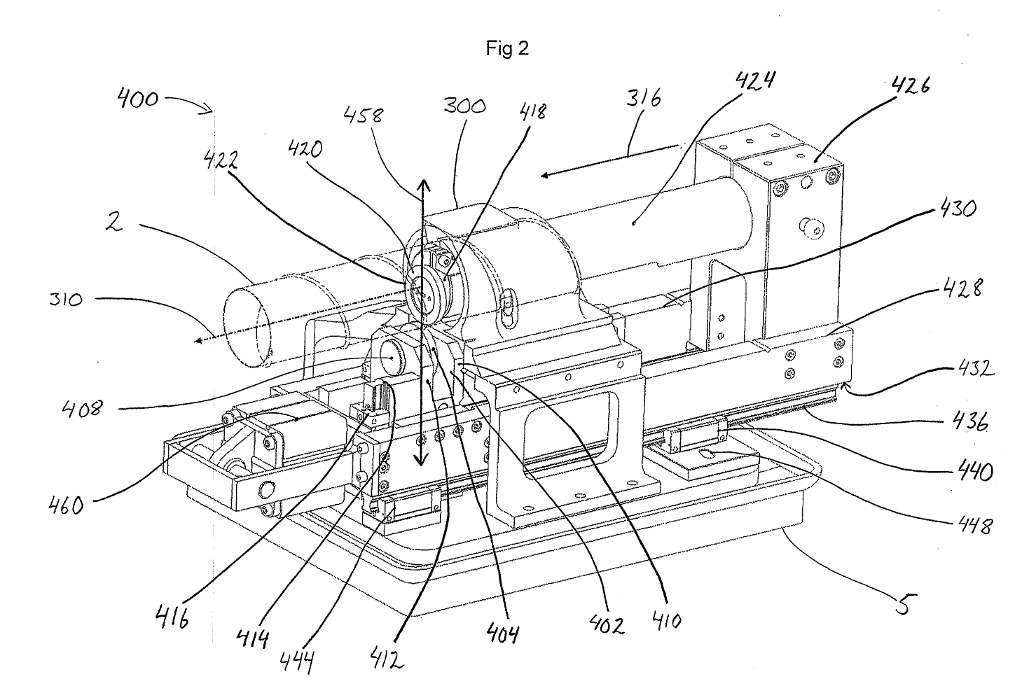

FIG. 2 depicts a tube manufacturing device 1 according to FIG. 1 for manufacture of spirally formed tube 2. The tube manufacturing device 1 comprises the forming head 300 and the cutting unit 400. The cutting unit 400 comprises a knife holder 402 adapted to being movable towards the tube 2 to cutting position before cutting of the tube takes place. This direction is called the cutting direction 458. The continuous metal strip 6 running from a feed device 7 via the shaping mill 8 and the latter's powered rollers is led towards the forming head 300 disposed on the tube manufacturing device 1. As mentioned above, the shaping mill 8 is preferably situated in the immediate vicinity of the tube manufacturing device 1 in such a way that they are connected to one another. Their being connected to one another thus makes it possible for the strip 6 to be led into the tube manufacturing device 1 in an unvarying manner. This means that the manufacturing process need not be interrupted for adjustment of the way the strip 6 enters the tube manufacturing device 1.

The forming head 300 is adapted to receiving the strip 6 in an inlet 302 to the forming head 300 (features pertaining to the forming head are not depicted in the drawing). In a cross-section through the forming head 300, the inlet 302 is U-shaped and has a bottom 304. The U shape comprises a first leg 306 and a second leg 308 each disposed on either respective side of the bottom 304. The respective legs 306 and 308 each have a surface which faces towards a centreline 310 extending through the forming head 300. The surface for the first leg 306 is called the first slide surface 312. The surface for the second leg 308 is called the second slide surface 314. The strip 6 fed in via said inlet 302 to the forming head 300 is led in a looplike movement along the slide surfaces 312 and 314. After the strip 6 has undergone approximately one revolution inside the forming head 300, one edge region of the strip 6 meets the other edge region. A pressing element situated at the junction between the edge regions continuously seams the respective edge regions together (not depicted in the drawing), resulting in a spiral shape which constitutes the tube 2. The forming of a tube 2 thus takes place in the forming head 300. The finished tube 2 leaves the forming head 300 in a feed direction 316 which is parallel to the centreline 310 of the forming head 300.

When the tube 2 has been made to a desired length, it has to be cut. This is done by the cutting unit 400 disposed in the tube manufacturing device 1. The cutting unit 400 is so disposed in the tube manufacturing device 1 as to be capable of being regulated independently of the forming head 300 which is also disposed in the tube manufacturing device 1. This is described in more detail further on in the text with regard to regulation of cutting angle. As above, the cutting unit 400 comprises a knife holder 402.

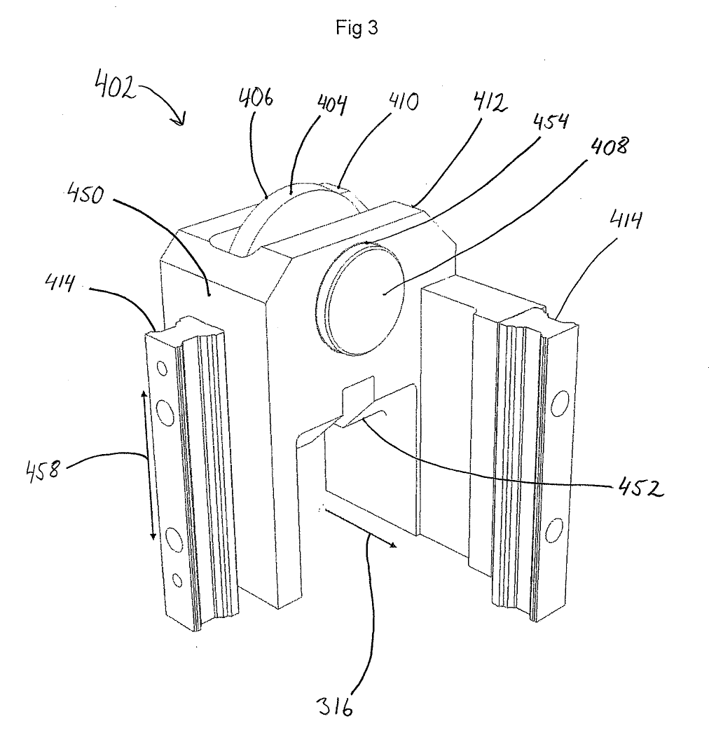

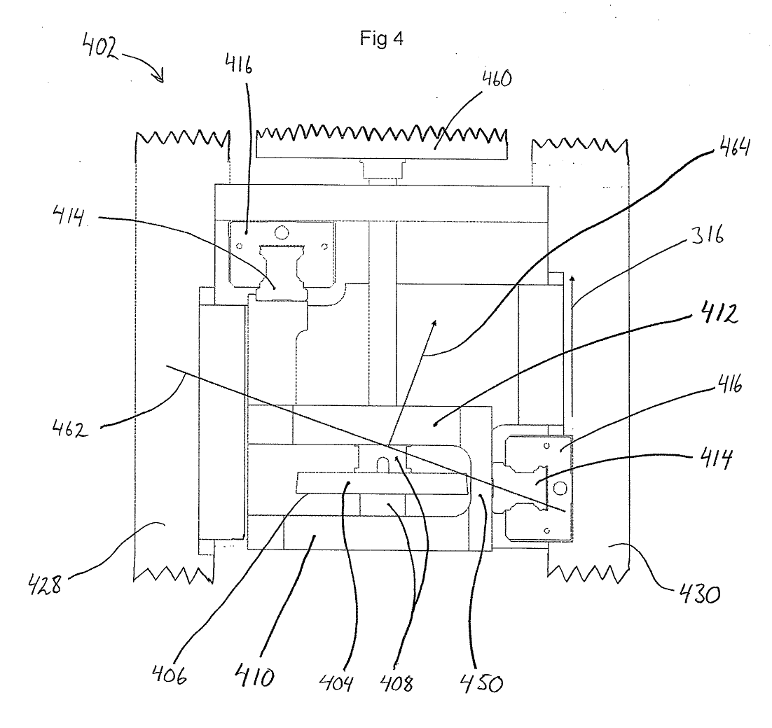

FIG. 3 shows the knife holder 402 situated, in the feed direction 316, after the forming head 300. The knife holder 402 comprises a knife element 404. This knife element 404 is circular and provided with a cutting edge 406 along its periphery. The knife element 404 is fitted in the knife holder 402 via a shaft 408. The shaft 408 is supported by the knife holder 402 by means of at least one shaft-bearing part 410 and 412, each preferably in the form of a recess (shaft-bearing part) in which the shaft 408 is fitted. The knife holder 402 is adapted to be movable in the cutting unit 400. During cutting, the knife holder 402 with the knife element 404 has to travel to a position for cutting the tube 2. This position is such that the knife element 404 with its cutting edge cuts through the surface of the tube 2 at the region which is to be cut. The knife holder 402 travels in the cutting direction 458 to the cutting position through so-called linear units disposed between the knife holder 402 at least two points and the cutting unit 400. Each linear unit takes the form of a bearing element 414 which cooperates with a fastening element 416 (see FIGS. 2 and 4).

FIG. 4 shows the bearing element 414 fitted on the knife holder 402. The respective fastening element 416 is situated on the cutting unit 400 opposite to a side of the knife holder 402 which comprises the bearing element 414. Via the linear unit, the knife holder 402 with the knife element 404 is thus adapted to being movable in the cutting unit 400. The knife holder 402 is moved to the cutting position by a force acting upon the knife holder 402 from below. This force may come from a controlled power unit 460 (force generating unit) (see FIGS. 2 and 4), e.g. a hydraulic compact cylinder, or a fitted toggle joint which is acted upon pneumatically, hydraulically or mechanically.

A back-up 418 is disposed opposite to the knife holder 402 (see FIG. 2). The back-up 418 cooperates with the knife holder 402 and the latter's knife element 404. The back-up takes the form of a second knife element 420 with a second cutting edge 422. The back-up 418 is fitted on one end of a bearing arm 424. The other end of the bearing arm 424 is fitted in a body 426 which is firmly connected to the cutting unit 400. In the feed direction 316, the body 426 is situated before the forming head 300. The bearing arm 424 extends with the back-up 418 through the forming head 300 parallel with the centreline 310. During cutting, the knife element 404 on the knife holder 402 and the second knife element 420 on the back-up 418 are so disposed relative to one another that their respective cutting edges 406 and 422 overlap one another. The overlap may be likened to how the blades of a pair of scissors relate to one another when cutting through, for example, a sheet of paper.

The cutting unit 400 comprises a first beam element 428 and a second beam element 430 which are parallel to one another. Between the beam elements 428 and 430 (see FIG. 2), the body 426 is disposed at one end of the beam elements 428 and 430, where it is connected firmly to them by connecting elements. Between the beam elements 428 and 430, a short distance in from the other end, the knife holder 402 is connected movably to them via said bearing elements 414 and fastening elements 416.

A second linear unit is disposed on the respective underside 432 and 434 of each beam element 428 and 430. This second linear unit takes the form of respective first and second rails 436 and 438 connected to the respective first and second undersides 432 and 434 via connecting elements (the drawing does not show 438 and 434). At the end of the beam elements 428 and 430 comprising the body 426, the respective rails 436 and 438 are disposed in respective first and second rear runners 440 and 442 (the drawing does not show 442). In the region of the knife holder 402, the rails 436 and 438 are disposed in respective first and second forward runners 444 and 446 (the drawing does not show 446). The rear runners 440 and 442 are disposed parallel to one another on the cutting unit 400. A setting element 448 is adapted to be movable on a worktable 5 for the cutting unit 400. The forward runners 444 and 446 are disposed parallel to one another and are rotatable with the worktable 5. The setting element 448 is so disposed that the rear portion of the cutting unit 400 can be regulated sideways on the worktable 5 about a respective axis between the worktable 5 and the respective forward runners 444 and 446. The rear portion of the cutting unit 400 can be regulated to set a correct cutting angle for the knife element 404 relative to the feed direction 316 of the tube 2 leaving the forming head 300. Setting an incorrect cutting angle will result, during the cutting operation, in the section cut through the tube 2 by the knife element 404 not ending where it began, causing the formation between two pipe sections of an edge, or portion, which will continue to hold the pipes together. This edge has then to be cut away or broken off for the tube 2 to be fully cut.

The knife holder 402 (see FIGS. 3 and 4) as above is configured to be disposed in said cutting unit 400 in a tube manufacturing device 1. The knife holder 402 comprises first and second shaft-bearing parts 410 and 412. A wall element 450 is disposed between the shaft-bearing parts 410 and 412. The shaft-bearing parts 410 and 412 and the wall element 450 constitute together a shape similar to a U-beam. A bottom element 452 is disposed against one end of the shaft-bearing parts 410 and 412. In a region on the other end of the respective shaft-bearing parts 410 and 412, opposite to the end adjacent to the bottom element, a shaft 408 is disposed between the shaft-bearing parts 410 and 412. The shaft 408 is fitted in respective recesses 454 (the drawing only shows one recess) disposed in the respective shaft-bearing parts 410 and 412. The shaft 408 is fitted in each recess 454 with a bearing 456 (not depicted in the drawing). This makes it possible for the shaft 408 to rotate with low friction in the respective recesses 454. The shaft 408 supports the knife element 404. The knife element 404 is disposed centrally on the shaft with a centre of gravity situated at the centreline of the shaft 408. The weight of the knife element 404 and a force against that weight are distributed evenly on the respective shaft-bearing parts 410 and 412 which support the shaft 408 and the knife element 404.

Motion of the knife element 404 in the cutting direction 458 towards or away from the position for cutting a tube 2 is imparted by a pushing or pulling force acting upon the bottom element 452. Pushing moves the knife holder 402 towards cutting position. Pulling moves the knife holder 402 away from cutting position. The configuration of the bearing elements 414 and fastening elements 416 is with advantage similar to that depicted for the rails and runners belonging to the second linear unit as described above. Each bearing element 414 then takes the form of a rail with a cross-section corresponding to the rail disposed against the respective beam element 428 and 430. Each fastening element 416 then takes the form of a respective runner corresponding to the runner for the respective rail of said beam elements 428 and 430.

According to an embodiment, two bearing elements 414 are disposed on opposite sides of the knife holder 402.

According to a further embodiment, the two bearing elements 414 may be disposed with one bearing element situated on one side of the knife holder 402 and with the other bearing element situated on another side of the knife holder 402, which sides are not opposite. In FIG. 4, this is illustrated by an imaginary plane 462 running through the respective bearing element 414 of the knife holder 402. The plane 462 runs in FIG. 4 parallel to the cutting direction 458. The plane 462 has a perpendicular vector 464 from the plane 462. As the bearing elements 414 are not disposed exactly opposite one another, the result is that the plane according to the drawing therefore has the normal vector 464 which differs from being parallel to the feed direction 316.

According to an embodiment, before cutting of the tube, the knife holder 402 may be moved to its cutting position by a compact cylinder. The compact cylinder pushes in the direction of movement of the knife holder.

According to a further embodiment, before cutting of the tube, the knife holder 402 may be moved to cutting position by a toggle joint. The toggle joint will be controlled by a force-generating element disposed, for example, in the feed direction in front of the knife holder 402 in the tube manufacturing device 1. The toggle joint will be so disposed that when the knife holder 402 is in its cutting position, the toggle joint will have assumed a position such that in the direction of movement of the knife holder 402 the toggle joint is rigid.

The invention is not limited to the embodiment depicted but may be varied and modified within the scope of the claims set out below, as partly described above.

### REFERENCE NOTATIONS

1. tube manufacturing device
2. tube (spirally formed)
300. forming head
400. tube cutting unit
5. worktable
6. metal strip
7. feed device
8. shaping mill
302. inlet
304. bottom
306. first leg
308. second leg
310. centreline
312. first slide surface
314. second slide surface
316. feed direction
402. knife holder
404. knife element
406. cutting edge
408. shaft
410. first shaft-bearing part
412 second shaft-bearing part
414. bearing element
416. fastening element
418. back-up
420. second knife element
422. second cutting edge
424. bearing arm
426. body
428. first beam element
430. second beam element
432. first underside
434. second underside
436. first rail
438. second rail
440. first rear runner
442. second rear runner
444. first forward runner
446. second forward runner
448. setting element
450. wall element
452. bottom element
454. recess
456. bearing
458. cutting direction
460. power unit
462. plane
464. perpendicular/normal vector

1. A knife holder (402) for a tube cutting unit (400), which tube cutting unit (400) is adapted to receiving a rotating tube (2) fed outs from a tube manufacturing device (1) in a feed direction (316) which for one length unit is parallel with the longitudinal direction of the tube (2), such that rotation takes place about an axis (310) in the longitudinal direction of the tube (2), wherein the knife holder (402) is configured to be movable via bearing elements (414) on the knife 10 holder (402) which communicates with fastening elements (416) disposed on the tube cutting unit (400), the knife holder (402) comprises first and second shaft-bearing parts (410, 412) and there is between the shaft-bearing parts a shaft (408) which supports a centred knife element (404) with cutting edge (406), wherein a back-up (418) is situated opposite to the knife element (404) in such a way that the back-up (418) is within the periphery of the tube (2) being made and cooperates with the knife element (404) during the cutting operation.

2. A knife holder (402) for a tube cutting unit (400) according to claim 1, wherein the position of the knife element (404) along the shaft (408) between the shaft-bearing parts (410, 412) can be varied.

3. A knife holder (402) for a tube cutting unit (400) according to claim 1, wherein the knife element (404) is adapted to be rotatable.

4. A knife holder (402) for a tube cutting unit (400) according to claim 1, wherein the knife element (404) is adapted to cutting the tube (2) in a direction transverse to the tube's longitudinal direction.

5. A knife holder (402) for a tube cutting unit (400) according to claim 1, wherein each shaft-bearing part (410, 412) has a recess (454) in which the shaft (408) is fitted.

6. A knife holder (402) for a tube cutting unit (400) according to claim 1, wherein the shaft (408) is adapted to being journalled in at least one shaft-bearing part (410, 412).

7. A knife holder (402) for a tube cutting unit (400) according to claim 1, wherein the knife holder (402) comprises a wall element (450) disposed between the shaft-bearing parts (410, 412).

8. A knife holder (402) for a tube cutting unit (400) according to claim 1, wherein the knife holder (402) comprises a bottom element (452) from which the shaft-bearing parts (410, 412) protrude.

9. A knife holder (402) for a tube cutting unit (400) according to claim 1, wherein the bearing elements (414) on the knife holder (402) are disposed in an imaginary plane (462) which has a perpendicular vector (464) which deviates from being parallel with the longitudinal direction, or feed direction (316), of the tube (2).

10. A knife holder (402) for a tube cutting unit (400) according to claim 1, wherein the bearing elements (414) on the knife holder (402) are disposed in an imaginary plane (462) which has a perpendicular vector (464) to the plane which is parallel with the longitudinal direction, or feed direction (316), of the tube (2).

11. A tube cutting unit (400) for a tube manufacturing device (1) comprising a knife holder (402) according to claim 1 above.

12. A system comprising a tube manufacturing device (1) and a tube cutting unit (400) according to claim 11 above.

13. Use of a tube cutting unit (400) for manufacture of tubes, comprising a tube manufacturing device (1) and a tube cutting unit (400) according to claim 12.
